(19) United States
(12) Patent Application Publication
(10) Pub. No.: US 2024/0161077 A1
(43) Pub. Date: May 16, 2024

(54) Concept for Performing Operations on an Asset

(71) Applicant: Intel Corporation, Santa Clara, CA (US)

(72) Inventors: Clair Michael BOWMAN, Boise, ID (US); Prakash NARAYANA MOORTHY, Beaverton, OR (US); Bruno VAVALA, Hillsboro, OR (US); Marcela S. MELARA, Beaverton, OR (US)

(21) Appl. No.: 18/343,797

(22) Filed: Jun. 29, 2023

(51) Int. Cl. G06Q 20/12; G06Q 20/10; G06Q 20/38

(52) U.S. Cl. CPC G06Q 20/1235; G06Q 20/10; G06Q 20/3829; G06Q 2220/00

(57) ABSTRACT

Various examples relate to methods, apparatuses, device, computer programs, computer systems and systems. A method comprises obtaining, by a non-fungible token (NFT) smart contract being executed in a trusted execution environment, a request to perform an operation using the asset, providing, by the NFT smart contract, the request for a service for providing access to the asset if the request is obtained from a current owner of the NFT smart contract, obtaining, by the NFT smart contract, a result provided by the service for providing access to the asset, the result being based on the request, and providing, by the NFT smart contract, the result for the current owner of the NFT smart contract.

### BACKGROUND

In many cases, Non-Fungible Tokens (NFTs) are created and traded for artifacts such as images, artworks, etc. where the NFT owner typically gets full rights to view/use the “raw bytes” of the artifact (e.g., download the image/artwork as is). Popular NFT smart contracts currently used, such as ERC729 or ERC1155 (in Ethereum), offer little support to enable trustworthy trading of “policy-based usage of the artifact” without revealing the asset itself to the NFT owner. In the context of high-value confidential assets such as machine learning models or datasets that could be used to build the model itself, such an approach is infeasible, as the asset itself is usually available to everyone, with the NFT merely proving ownership of the asset.

### BRIEF DESCRIPTION OF THE FIGURES

Some examples of apparatuses and/or methods will be described in the following by way of example only, and with reference to the accompanying figures, in which:

FIGS. 1a to 1d show flow charts of examples of aspects of a method for performing an operation on an asset via a NFT smart contract;

FIG. 1e shows a block diagram of an apparatus or device for performing an operation on an asset via a NFT smart contract, of a computer system comprising such an apparatus, and of a system comprising two computer systems;

FIG. 1f shows a schematic diagram of a system comprising an NFT smart contract and a service;

FIGS. 2a to 2d show flow charts of examples of aspects of a method for a service for providing access to an asset;

FIG. 2e shows a block diagram of an apparatus or device for a service for providing access to an asset, of a computer system comprising such an apparatus, and of a system comprising two computer systems;

FIG. 3 shows a schematic diagram of an example of an NFT infrastructure;

FIG. 4 shows a schematic diagram of an example of an architecture to enable NFTs for high-value confidential assets;

FIG. 5 shows a schematic diagram of an NFT sub-system showing components involved in the proposed secure data exchange protocol;

FIG. 6 illustrates operations performed during initialization of a token issuer smart contract according to an example;

FIG. 7 illustrates operations performed during creation of a NFT smart contract according to an example;

FIG. 8 illustrates operations performed during transfer of ownership of a NFT smart contract according to an example;

FIG. 9 illustrates operations performed when invoking an operation according to an example;

### DETAILED DESCRIPTION

Some examples are now described in more detail with reference to the enclosed figures. However, other possible examples are not limited to the features of these embodiments described in detail. Other examples may include modifications of the features as well as equivalents and alternatives to the features. Furthermore, the terminology used herein to describe certain examples should not be restrictive of further possible examples.

Throughout the description of the figures same or similar reference numerals refer to same or similar elements and/or features, which may be identical or implemented in a modified form while providing the same or a similar function. The thickness of lines, layers and/or areas in the figures may also be exaggerated for clarification.

When two elements A and B are combined using an “or”, this is to be understood as disclosing all possible combinations, i.e., only A, only B as well as A and B, unless expressly defined otherwise in the individual case. As an alternative wording for the same combinations, “at least one of A and B” or “A and/or B” may be used. This applies equivalently to combinations of more than two elements.

If a singular form, such as “a”, “an” and “the” is used and the use of only a single element is not defined as mandatory either explicitly or implicitly, further examples may also use several elements to implement the same function. If a function is described below as implemented using multiple elements, further examples may implement the same function using a single element or a single processing entity. It is further understood that the terms “include”, “including”, “comprise” and/or “comprising”, when used, describe the presence of the specified features, integers, steps, operations, processes, elements, components and/or a group thereof, but do not exclude the presence or addition of one or more other features, integers, steps, operations, processes, elements, components and/or a group thereof.

In the following description, specific details are set forth, but examples of the technologies described herein may be practiced without these specific details. Well-known circuits, structures, and techniques have not been shown in detail to avoid obscuring an understanding of this description. “An example/example,” “various examples/examples,” “some examples/examples,” and the like may include features, structures, or characteristics, but not every example necessarily includes the particular features, structures, or characteristics.

Some examples may have some, all, or none of the features described for other examples. “First,” “second,” “third,” and the like describe a common element and indicate different instances of like elements being referred to. Such adjectives do not imply element item so described must be in a given sequence, either temporally or spatially, in ranking, or any other manner. “Connected” may indicate elements are in direct physical or electrical contact with each other and “coupled” may indicate elements co-operate or interact with each other, but they may or may not be in direct physical or electrical contact.

As used herein, the terms “operating”, “executing”, or “running” as they pertain to software or firmware in relation to a system, device, platform, or resource are used interchangeably and can refer to software or firmware stored in one or more computer-readable storage media accessible by the system, device, platform, or resource, even though the instructions contained in the software or firmware are not actively being executed by the system, device, platform, or resource.

The description may use the phrases “in an example/example,” “in examples/examples,” “in some examples/examples,” and/or “in various examples/examples,” each of which may refer to one or more of the same or different examples. Furthermore, the terms “comprising,” “including,” “having,” and the like, as used with respect to examples of the present disclosure, are synonymous.

Various examples of the present disclosure relate to a concept for using NFTs to trade “policy-based usage-rights” to high-value assets, instead of using NFTs to just trade “raw-bytes of at the asset”. The present disclosure proposes systems and protocols to facilitate NFTs for high-value confidential assets, including techniques to create NFTs for high-value confidential assets.

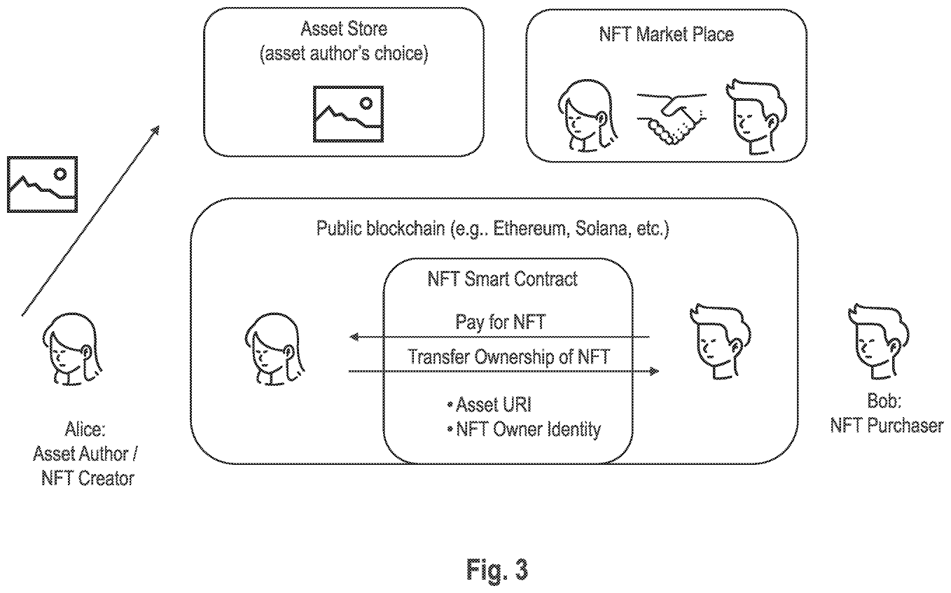

In the following, a more detailed overview of the existing NFT architecture is given (e.g., as shown in FIG. 3), highlighting its inefficiencies with respect to supporting high-value confidential assets. To create an NFT today, the asset author carries out three operations: First, the user uploads the asset into an asset store. Then, the asset author creates/deploys an NFT smart contract in Ethereum (a trademark of Stiftung Ethereum/Ethereum Foundation), Solana (a trademark of Solana Foundation), etc. The NFT smart contract at its core contains the URI (Uniform Resource Identifier) to the asset, as well as specifies who owns the NFT. Finally, the asset author lists the NFT for sale in an NFT marketplace, such as OpenSea (OpenSea, n.d.) (a trademark of Ozone Networks, Inc.) or OceanMarketplace (Ocean Protocol, n.d.). A prospective buyer of the NFT initiates the buy-process via the NFT marketplace, which behind the scenes interacts with the NFT smart contract to ensure that Bob pays Alice, and the NFT ownership (as recorded in the NFT smart contract) changes from Alice to Bob.

However, the following inefficiencies about the above architecture, that limit its usability for creating NFTs for high-value confidential assets, are noted. In general, there is only a very weak binding between the NFT smart contract and the asset. This is because ownership of the NFT does not imply ownership of the asset held in the asset store. In other words, what the NFT owner gets to do with the asset is completely dependent on the implementation of the asset store. The NFT owner is constantly under the threat of facing a DoS (Denial of Service) attack, where the asset gets removed from the asset-store despite owning the NFT. In addition, the architecture does not have any provision for the NFT smart contract to specify a policy around how the asset should be used, while at the time be able to communicate with the asset-store to ensure that the policy gets enforced. Moreover, the NFT smart contract, being public in nature, cannot be used to either store any confidential information (such as a decryption key to the asset), or execute a compute-logic that contains confidential information.

Some approaches to support policies that determine usage of the asset by the NFT owner are implemented “out-of-band” with the NFT smart contract itself and involve implementation either via the asset store layer or at a centralized location by the provider of the NFT marketplace. This is a centralized way to address the policy-support problem required to implement NFTs that have right to use and not right to see. Given the lack of decentralization of such an approach, scalable adoption seems unlikely. Moreover, some approaches for supporting NFTs for confidential assets are challenged by the challenge of having to securely store the asset or decryption keys to the asset. Today, these keys/assets are stored directly either with the asset-store or a centralized marketplace service provider. This approach is highly prone to DoS attacks (for the token owner) and lack of trust by the asset author (to yield control of keys to a third-party marketplace provider).

Two-layer (Layer 1/Layer 2) architectures for blockchains are a well-known concept and are used to provide functionality via Layer 2 that cannot be directly provided by Layer 1 alone. However, such two-layer blockchain approaches might not have been used for rolling out NFTs that addresses the needs for policy-support as well as support for confidential-assets. In the following, a secure data-exchange protocol is presented to use such a two-layer infrastructure to implement “policy-based usage-rights” to high-value assets.

In the present disclosure, systems and protocols are proposed that may address the above inefficiencies so that description/enforcement of asset-usage policies can be implemented as part of the NFT smart contract itself, thereby widely enhancing the scope of what can be done with NFTs. In the following, it is discussed how the proposed system can be used to create/deploy NFTs for high-value confidential assets.

Instead of implementing the NFT smart contract in a public blockchain, in the proposed concept, the NFT smart contract is implemented in a Trusted Execution Environment (TEE)-enabled blockchain. The NFT smart contract might not only be used to implement ownership, but also to implement/evaluate policy to be followed while using the confidential asset. The smart contract, after policy evaluation, may generate asset-usage capabilities that get processed by capability execution engines implemented inside asset stores. The NFT smart contract may share confidential information with the asset store only after verifying its trustworthiness (per policies implemented inside the smart contract). Usage of TEEs, such as Intel® SGX (Software Guard Extensions) for the NFT contract is used to harden the enforcement of policies to generate and release capabilities for using the asset in the asset store.

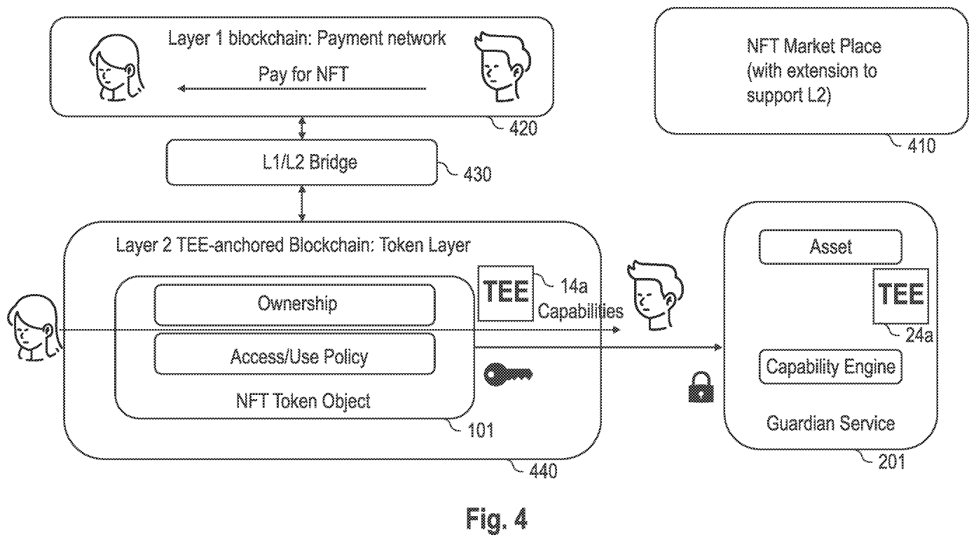

To implement the proposed concept, the NFT blockchain architecture may be split into two pieces: a public Layer 1 blockchain such as Ethereum/Solana to act as the payment layer, and a TEE-anchored Layer 2 blockchain, bridged to Layer 1, within which the NFT smart contract as described above is implemented. Receipt of payment from layer 1 may be used to initiate transfer of ownership in layer 2. Two layers are used since there are no public blockchains that can run smart contracts within TEEs. The proposed architecture is shown in FIG. 4, for example. The proposed concept includes the secure data-exchange protocols that are used to realize this architecture.

The proposed concept may be used to implement an NFT based marketplace for licensing of machine learning models, e.g., on top of technologies provided by OpenVINO™, providing a significant improvement over previous approaches for licensing ML models (OpenVINO Security, n.d.). The proposed concept may be used to create several key enabler components to put together a scalable marketplace for exchange/trading of confidential assets, with applications to AI and security. Finally, the proposed system and protocols may be used as the foundation layer to enable creation/usage of “self-sovereign datasets”, i.e., a dataset whose usage policies are described/enforced by the dataset itself, and not determined by a license-holder of the data-asset.

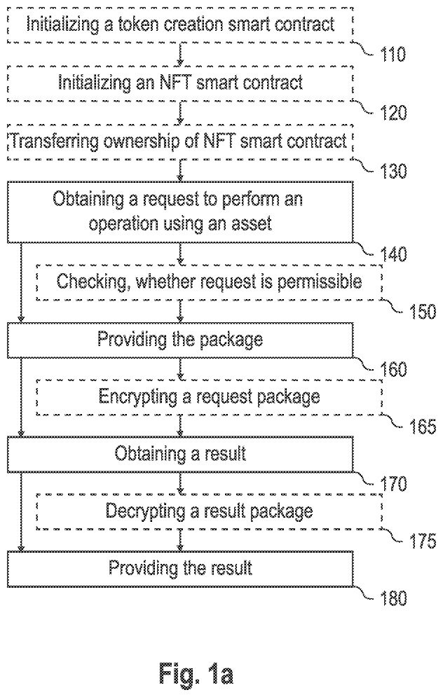

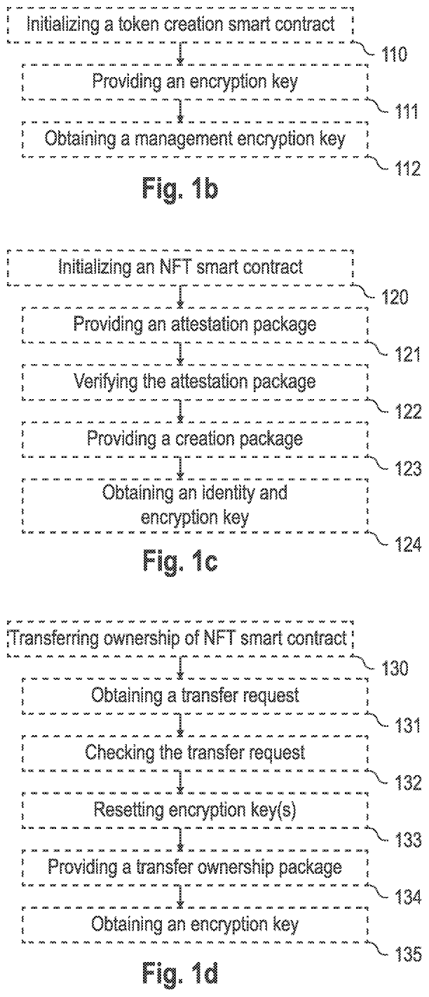

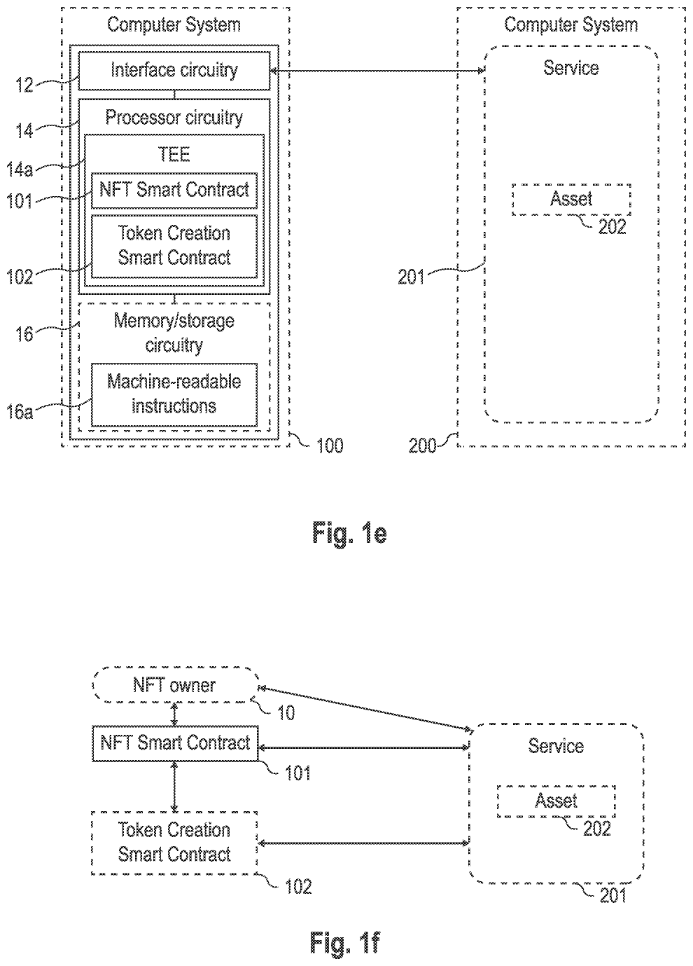

FIGS. 1a to 1d show flow charts of examples of aspects of a method for performing an operation on an asset via a NFT smart contract. While FIG. 1a gives an overview of the method, FIGS. 1b to 1d relate to specific, optional aspects of the method. The method comprises obtaining 140, by a NFT smart contract 101 (shown in FIGS. 1e and 1f, for example) being executed in a trusted execution environment 14a (shown in FIG. 1e), a request to perform an operation using the asset. The method comprises providing 160, by the NFT smart contract, the request (e.g., as part of a request package) for a service for providing access to the asset if the request is obtained from a current owner of the NFT smart contract. The method comprises obtaining 170, by the NFT smart contract, a result (e.g., as part of a result package) provided by the service for providing access to the asset, the result being based on the request package. The method comprises providing 180, by the NFT smart contract, the result (contained in the result package) for the current owner of the NFT smart contract. For example, the method may be performed by an apparatus 10, device 10 or a computer system 100, such as shown in FIG. 1e.

FIG. 1e shows a block diagram of an apparatus 10 or device 10 for performing an operation on an asset via a NFT smart contract. The apparatus 10 comprises an interface 12 for communicating with a service 201 for providing access to an asset 202. The apparatus 10 comprises machine-readable instructions 16a. The apparatus comprises processor circuitry 14 with a trusted execution environment 14a to execute the machine-readable instructions inside the trusted execution environment to perform the method of at least one of FIGS. 1a to 1d. For example, the processor circuitry 14 may be coupled with the interface circuitry 12. For example, the processor circuitry 14 may provide the functionality of the apparatus, in conjunction with the interface circuitry 12 (for exchanging information, e.g., with the service 201 and/or a computer system 200 hosting the service 201). In some examples, the processor circuitry may further comprise memory/storage circuitry 16 for storing information, with the memory circuitry 16 being coupled to the processor circuitry 14. For example, the memory circuitry 16 may include at least one of flash memory, volatile memory and/or non-volatile memory. Likewise, the device 10 may comprise means for providing the functionality of the device 10. For example, the means may be configured to provide the functionality of the device 10. The components of the device 10 are defined as component means, which may correspond to, or implemented by, the respective structural components of the apparatus 10. For example, the device 10 of FIG. 1e comprises means for processing 14, which may correspond to or be implemented by the processor circuitry 14, means for communicating 12, which may correspond to or be implemented by the interface circuitry 12, and (optional) storage/memory 16, which may correspond to or be implemented by the memory/storage circuitry 16. In some examples, the functionality of the processor circuitry 14 or means for processing 14 may be implemented by the processor circuitry 14 or means for processing 14 executing machine-readable instructions. Accordingly, any feature ascribed to the processor circuitry 14 or means for processing 14 may be defined by one or more instructions of a plurality of machine-readable instructions. The apparatus 10 or device 10 may comprise the machine-readable instructions 16a, e.g., within the memory/storage circuitry 16 or within the TEE 14a of the processor circuitry/means for processing 14.

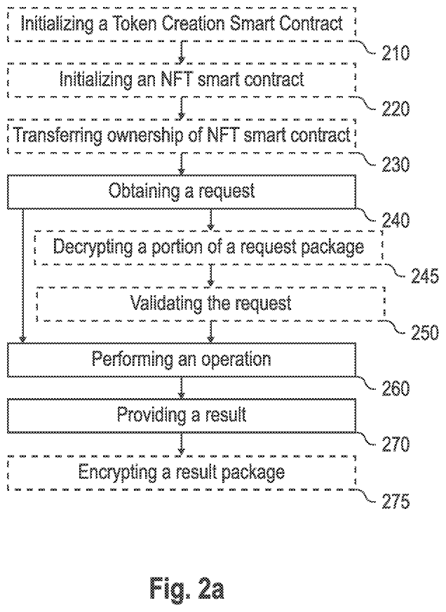

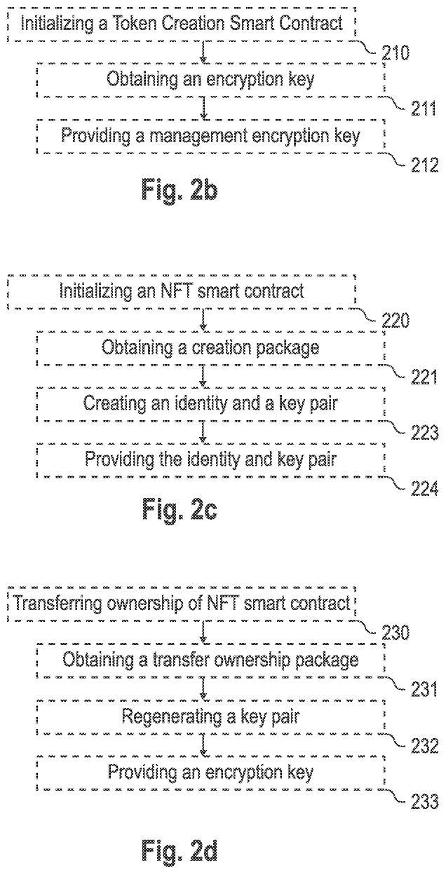

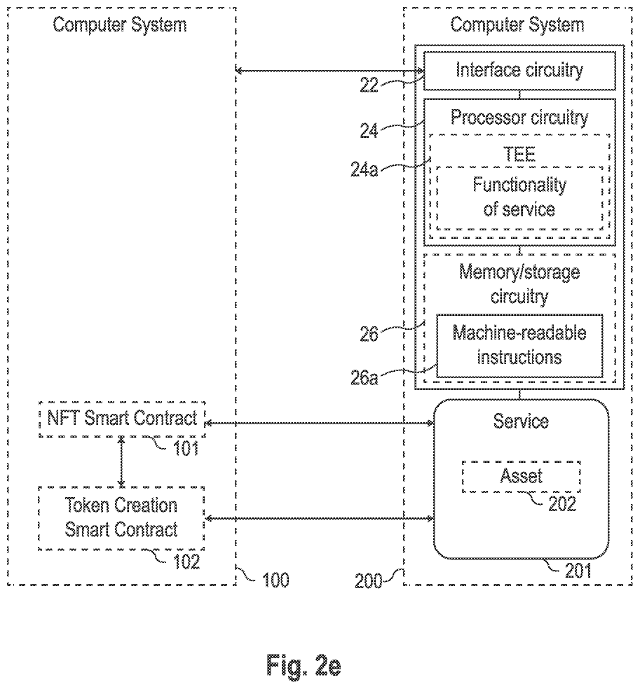

FIG. 1e further shows a computer system 100 comprising the apparatus 10 or device 10. FIG. 1e further shows a system comprising the computer system 100 with the apparatus 10 or device 10 and a further computer system 200 hosting the service 201. Another system may include the apparatus 10/device 10 of FIG. 1e and an apparatus 20/device 20 of FIG. 2e.

In FIG. 1f, the main actors of the proposed concept are shown—the NFT smart contract 101, an optional token creation smart contract 102, and the service 201. In connection with FIGS. 4 to 9, the NFT smart contract 101 is also referred to as NFT Token Object Smart Contract, the token creation smart contract 102 is also referred to as Token Creation Smart Contract, and the service 201 is also referred to as Guardian Service. FIG. 1f shows a schematic diagram of a system comprising the NFT smart contract 101 and the service 201. Optionally, the system further comprises the token creation smart contract 102.

In the following, various aspects of the method, of a corresponding computer program, of the apparatus 10 or device 10, and of the computer system 100 are discussed in more detail with reference to the method of FIGS. 1a to 1d. Features introduced in connection with the method may likewise be implemented in the corresponding computer program, apparatus 10, device and computer system 100.

As outlined above, the proposed concept is based on handling access to an asset, and in particular access to usage of an asset, i.e., operations being performed on an asset, via an NFT smart contract being executed in a Trusted Execution Environment. A Trusted Execution Environment (TEE) is a secure area within a device's hardware that operates in a fully isolated and secured environment. A TEE is typically used to protect sensitive data, such as cryptographic keys and other confidential information, from being accessed or tampered with by unauthorized parties. The TEE is designed to be completely separate from the main operating system and applications, making it highly resistant to attacks that could compromise security. In the proposed concept, the TEE is used to implement a TEE-anchored blockchain (which may be operated as a Layer 2 blockchain), with the smart contracts of the blockchain being stored (or at least decrypted) in the TEE. Thus, NFT smart contract 101, as well as the optional token creation smart contract 102, are only accessible from within the TEE, protecting the information stored within the smart contract, such as keys for proving to the service that the request package being provided is legitimate.

The proposed concept is based on NFT smart contracts being executed in the TEE of the processor of the computer system. A smart contract is a self-executing program or agreement that is written in code and runs on a blockchain, e.g., the Layer 2 blockchain anchored in the TEE. A smart contract is designed to enforce the terms of an agreement between two or more parties without the need for a middleman. In the present case, the NFT smart contract is used for two purposes—to document ownership of the NFT smart contract (and therefore also to a right to perform an operation on the asset), and to forward the request (and, for example formulate the request package) to the service 201. In connection with FIGS. 4 to 9, such a request package comprises a so-called capability, which represents and includes the request for performing the operation on the asset, and which is cryptographically secured. In effect, the NFT smart contract grants the current owner of the NFT smart contract the right to perform one or more operations on the asset. This request package, and thus capability, is generated by the NFT smart contract. In addition, the NFT smart contract is used to provide (e.g., decrypt) the result to/for the current owner.

In the following, initialization of the setup, creation of the NFT smart contract and transfer of the NFT smart contract are discussed, which are optional aspects with respect to the usage of the NFT smart contract being primarily shown in FIG. 1a. The procedures shown in FIGS. 1b, 1c and 1d are optional, and merely provide an example for setting up the NFT smart contract contract and transferring ownership of the NFT smart contract to a new owner.

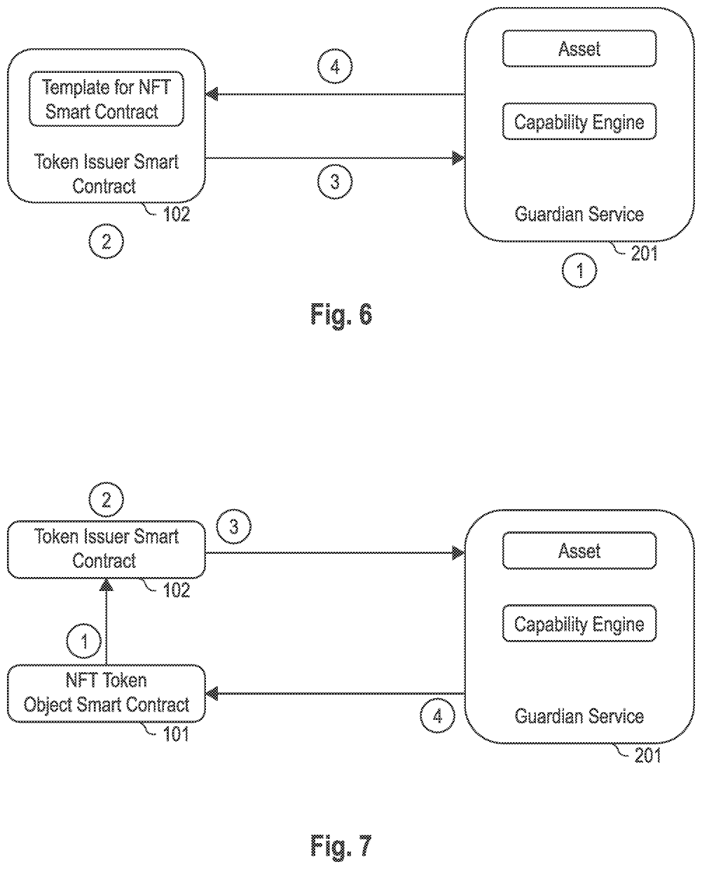

FIG. 1b shows an optional portion of the method that relates to initialization 110 of the token creation smart contract. Further aspects of the initialization of the token creation smart contract are discussed in connection with FIGS. 2b and 6. The Token creation smart contract is, like the NFT smart contract, executed in the TEE. For example, the method may comprise, to initialize 110 the token creation smart contract, providing 111, by the newly created token creation smart contract, an encryption key of the token creation smart contract to the service 201 for providing access to the asset. For example, the method may comprise creating (e.g., by an offering agent initially offering access to the asset) the token creation smart contract, e.g., according to a template. The method may further comprise generating, within the token creation smart contract, the encryption key of the token creation smart contract, e.g., as part of a key pair. For example, the encryption key of the token creation smart contract may be a public key of a key pair, with the token creation smart contract retaining the corresponding private key to decrypt information encrypted by the public key/encryption key. This encryption key may be used by the service 201 to encrypt its response to the token creation smart contract. For example, as part of the initialization of the token creation smart contract, the method may comprise obtaining 112, by the token creation smart contract, a management encryption key from the service for providing access to the asset. For example, the method may comprise decrypting a package comprising the management encryption key using the private key of the key pair generated by the token creation smart contract. The management encryption key may subsequently be used during creation of the NFT smart contract. In particular, a creation package for initializing a new NFT smart contract may be encrypted using the management encryption key. By obtaining the management encryption key, the token creation smart contract can prove its identity and authenticity towards the service 201, which allows the token creation smart contract to create new NFT smart contract. An example process for creating new NFT smart contracts is illustrated in FIG. 1c.

FIG. 1c shows an optional portion of the method that relates to initializing 120 of the NFT smart contract 101. Further aspects of the initialization of NFT smart contract are discussed in connection with FIGS. 2c and 7. For example, the method may comprise, e.g., by the offering agent, creating a new NFT smart contract, e.g., using a template included in the token creation smart contract. The user creating the NFT smart contract, e.g., the OA, may be set as current owner of the NFT smart contract.

The newly created NFT smart contract may then provide 121 an attestation package (defined by the code of the newly created NFT smart contract) to the token creation smart contract. To initialize 120 the NFT smart contract, the method may comprise verifying 122, by the token creation smart contract being executed in the trusted execution environment, the attestation package provided 121 by the newly created NFT smart contract. Initializing the NFT smart contract may further comprise providing 123, by the token creation smart contract, a creation package to the service 201 for providing access to the asset (after verification of the attestation package). For example, the creation package may comprise a capability specifying one or more operations that are permitted with respect to the request. For example, the method may comprise creating the capability, e.g., in accordance with the template of the NFT smart contract. The service 201 then creates an identity (e.g., an identifier) for the NFT smart contract, and generates a key pair (with a public key being provided as encryption key to the NFT smart contract, and a private key for decrypting the messages encrypted by the NFT smart contract). Initializing the NFT smart contract may further comprise obtaining 124, by the NFT smart contract, the identity (e.g., the identifier) and the encryption key being associated with the identity of the NFT smart contract from the service 201 for providing access to the asset. The encryption key may be used, by the NFT smart contract, to prove its identity towards the service 201. The encryption key may be provided in response to the creation package.

In general, the proposed concept is particularly useful in scenarios where the NFT smart contract is sold to a user wanting access to the asset, e.g., a user wanting to perform an operation on the asset. For this purpose, ownership of the NFT smart contract 101 may be transferred to the user. However, as outlined above, and shown in more detail in connection with FIG. 4, a two-layer approach may be used in this case. To be precise—handling the transfer of ownership may be done on a first (Layer 1) public blockchain, while handling access to the asset is done in the TEE-anchored blockchain on which the NFT smart contract is hosted. A Layer 1/Layer 2 bridge may be used to bridge between the block chain, with a change in ownership on the Layer 1 blockchain allowing or triggering a change of ownership on the Layer 2 blockchain that is handled inside the TEE.

FIG. 1d shows an optional portion of the method that relates to ownership transfer 130 of the NFT smart contract 101. Further aspects of the transfer of ownership of the NFT smart contract are discussed in connection with FIGS. 2d, 3, 4 and 8. The method may comprise, to transfer 130 the NFT smart contract to a new owner, by the NFT smart contract, obtaining 131 a transfer request to transfer ownership of the NFT smart contract, e.g., from a current owner of the NFT smart contract, which may initially be the offering agent/author of the asset. The NFT smart contract may then check 132, whether the transfer request is obtained from the current owner of the NFT smart contract (using cryptographic means, e.g., by checking that the current owner has signed the request to transfer ownership). The method may comprise, to transfer 130 the NFT smart contract to the new owner, by the NFT smart contract, resetting 133 one or more encryption keys contained in the NFT smart contract, e.g., in response to a corresponding request by the new owner. The method may comprise, to transfer 130 the NFT smart contract to a new owner, by the NFT smart contract, providing 134 a transfer ownership package for the service for providing access to the asset (e.g., to the service, or to the new owner). The service 201 may then create a new key pair (that is associated with the identity of the NFT smart contract, which remains) and provide the new encryption key to the NFT smart contract. Accordingly, the method may comprise, by the NFT smart contract, obtaining 135 an encryption key being associated with an identity of the NFT smart contract from the service for providing access to the asset, with the encryption key being provided in response to the transfer ownership package. For example, the encryption key may be provided, in a transfer package, by the new owner of the NFT smart contract. This encryption key may subsequently be used, by the NFT smart contract, to prove its identity towards the service 201. The new owner may now invoke the complete transfer method using the transfer package comprising the encryption key.

In the following, the procedure for performing operations, i.e., for using the NFT smart contract to perform the operations on the asset, is shown in more detail. The procedure starts, as shown in FIG. 1a, with obtaining 140, by the NFT smart contract 101, the request to perform an operation using the asset. The NFT smart contract acts as an intermediary between the requester and the service providing access to the asset and has two purposes—to verify that the request is obtained from the current owner, and to validate the request with respect to the usage rights conveyed by the NFT smart contract. As outlined above, the NFT smart contract grants the current owner of the NFT smart contract the right to perform one or more operations on the asset. In particular, the NFT smart contract defines, i.e., comprises information, which operation(s) are permitted by the NFT smart contract, i.e., which usage rights are conveyed to the current owner by the NFT smart contract. For example, the method may comprise checking 150, by the NFT smart contract, whether the request is permissible according to at least one pre-defined policy. For example, the pre-defined policy may be defined during creation of the NFT smart contract and codified by the NFT smart contract. The at least one pre-defined policy may specify the usage right or usage rights (on performing operations on the smart asset) being conveyed by the NFT smart contract.

The method comprises providing 160, by the NFT smart contract, the (request package comprising) the request for a service for providing access to the asset. For example, the request package may comprise a so-called capability, which includes the operation to be performed, the identity of the NFT smart contact, and a session key to be used for encrypting the result (encrypted by the encryption key provided by the service). For example, the session key may be a one-time key (to be used only for returning the result package) that is generated ad-hoc by the NFT smart contract. The request (package) is provided if the request is obtained from a current owner of the NFT smart contract, or if the request is obtained from the current owner of the NFT smart contract and the request is permissible according to the pre-defined policy. At least a portion of the request package, e.g., the session key, may be encrypted using the encryption key provided by the service. In other words, providing 160 the request may comprise encrypting 165, by the NFT smart contract, at least a portion of the request package using an encryption key provided by the service for providing access to the asset, with the encryption key being associated with an identity of the NFT smart contract. Other portions of the request package may also be encrypted. For example, as discussed in connection with the so-called capability, the operation to be performed may be encrypted using the session key (i.e., a corresponding other key of the key pair comprising the session key, or the session key itself if symmetric encryption is used).

The service 201 then validates the request and/or request package (e.g., both the capability and the encryption with the encryption key) and performs the operation if the validation is successful. In response to the request, the service 201 then provides the result (package). Thus, the method comprises obtaining 170, by the NFT smart contract, the result (package) provided by the service for providing access to the asset, with the result (package) being based on the request (package). In many cases, the result package may be encrypted, so only the NFT smart contract can access the result. For example, the act of obtaining the result may comprise decrypting 175, using the session key included in the request package, the result package.

In general, there are two approaches for a communication between the NFT smart contract and the service 201. In a first approach, the NFT smart contract and the service do not communicate directly with each other, but via the current owner. Instead, the current owner interacts with the NFT smart contract, obtains the request package from the NFT smart contract, and provides the request package to the service 201. The current owner may then also obtain the result from the service and provide it to the NFT smart contract for decryption. In other words, the NFT smart contract may provide the request package to the current owner of the NFT smart contract and obtain the result package from the current owner of the NFT smart contract. In a second approach, the NFT smart contract and the service communicate directly. In this case, the NFT smart contract provides the request (package) to the service for providing access to the asset and obtains the result (package) from the service for providing access to the asset.

In both cases, the NFT smart contract makes the result, e.g., after decryption, available to the current owner of the NFT smart contract. For this purpose, the method comprises providing 180, by the NFT smart contract, the (decrypted) result contained in the result package for the current owner of the NFT smart contract.

While the present concept has been discussed with some of the actions being triggered by the current owner, these actions may be triggered by a computer system of the current owner of the NFT smart contract, e.g., via an application programming interface. In other words, a computer system of the current owner of the NFT smart contract may interact with the NFT smart contract, and optionally with the service 201, via an application programming interface (e.g., provided by the Layer 2 blockchain).

The interface circuitry 12 or means for communicating 12 may correspond to one or more inputs and/or outputs for receiving and/or transmitting information, which may be in digital (bit) values according to a specified code, within a module, between modules or between modules of different entities. For example, the interface circuitry 12 or means for communicating 12 may comprise circuitry configured to receive and/or transmit information.

For example, the processor circuitry 14 or means for processing 14 may be implemented using one or more processing units, one or more processing devices, any means for processing, such as a processor, a computer or a programmable hardware component being operable with accordingly adapted software. In other words, the described function of the processor circuitry 14 or means for processing may as well be implemented in software, which is then executed on one or more programmable hardware components. Such hardware components may comprise a general-purpose processor, a Digital Signal Processor (DSP), a micro-controller, etc.

For example, the memory/storage circuitry 16 or memory/storage 16 may comprise at least one element of the group of a computer readable storage medium, such as a magnetic or optical storage medium, such as a random access memory, such as dynamic random-access memory (DRAM), a hard disk drive, a flash memory, Floppy-Disk, Random Access Memory (RAM), Programmable Read Only Memory (PROM), Erasable Programmable Read Only Memory (EPROM), an Electronically Erasable Programmable Read Only Memory (EEPROM), or a network storage.

More details and aspects of the method, computer program, apparatus 10, device 10, computer system 100 and system are mentioned in connection with the proposed concept, or one or more examples described above or below (e.g., FIGS. 2a to 9). The method, computer program, apparatus 10, device 10, computer system 100 and system may comprise one or more additional optional features corresponding to one or more aspects of the proposed concept, or one or more examples described above or below.

FIGS. 2a to 2d show flow charts of examples of aspects of a method for a service for providing access to an asset. While FIG. 2a gives an overview of the method, FIGS. 2b to 2d relate to specific, optional aspects of the method. The method comprises obtaining 240 (a request package comprising) a request to perform an operation using the asset. The request is provided by a NFT smart contract executed in a trusted execution environment (as shown in connection with FIGS. 1a to 1f. The method comprises performing 260, if the NFT smart contract grants an owner of the NFT smart contract to perform the operation using the asset, the operation included in the request. The method comprises providing 270 (a result package with) a result of the operation for the NFT smart contract. For example, the method may be performed by the service 201, e.g., by a computer system 200, apparatus 20 or device 20 hosting the service 201.

FIG. 2e shows a block diagram of an apparatus 20 or device 20 for a service for providing access to an asset. The apparatus 20 comprises an interface 22 for communicating with at least one smart contract being executed within a trusted execution environment (e.g., with the smart contract 101 being executed in the trusted execution environment 14a, as shown in FIGS. 1e and 10. The apparatus 20 comprises machine-readable instructions 26a. The apparatus comprises processor circuitry 24, which may comprise a trusted execution environment 24a, to execute the machine-readable instructions inside the trusted execution environment to perform the method of at least one of FIGS. 2a to 2d. For example, the processor circuitry 24 may be coupled with the interface circuitry 22. For example, the processor circuitry 24 may provide the functionality of the apparatus, in conjunction with the interface circuitry 22 (for exchanging information, e.g., with the NFT smart contract 101, the token creation smart contract 102, or a computer system 100 hosting the NFT smart contract 101 and/or the token creation smart contract 102). In some examples, the processor circuitry may further comprise memory/storage circuitry 26 for storing information, with the memory circuitry 26 being coupled to the processor circuitry 24. For example, the memory circuitry 26 may include at least one of flash memory, volatile memory and/or non-volatile memory. Likewise, the device may comprise means for providing the functionality of the device 20. For example, the means may be configured to provide the functionality of the device 20. The components of the device 20 are defined as component means, which may correspond to, or implemented by, the respective structural components of the apparatus 20. For example, the device 20 of FIG. 2e comprises means for processing 24, which may correspond to or be implemented by the processor circuitry 24, means for communicating 22, which may correspond to or be implemented by the interface circuitry 22, and (optional) storage/memory 26, which may correspond to or be implemented by the memory/storage circuitry 26. In some examples, the functionality of the processor circuitry 24 or means for processing 24 may be implemented by the processor circuitry 24 or means for processing 24 executing machine-readable instructions. Accordingly, any feature ascribed to the processor circuitry 24 or means for processing 24 may be defined by one or more instructions of a plurality of machine-readable instructions. The apparatus 20 or device 20 may comprise the machine-readable instructions 26a, e.g., within the memory/storage circuitry 26 or within the TEE 24a of the processor circuitry/means for processing 24.

FIG. 2e further shows a computer system 200 comprising the apparatus 20 or device 20. FIG. 2e further shows a system comprising the computer system 200 with the apparatus 20 or device and a further computer system 100 hosting the NFT smart contract 101 and/or the token creation smart contract 102.

In the following, various aspects of the method, of a corresponding computer program, of the apparatus 20 or device 20, and of the computer system 200 are discussed in more detail with reference to the method of FIGS. 2a to 2d. Features introduced in connection with the method may likewise be implemented in the corresponding computer program, apparatus 20, device and computer system 200.

While FIGS. 1a to if discuss the proposed concept with respect to the components running on the TEE-anchored blockchain, i.e., the NFT smart contract and the token creation smart contract, FIGS. 2a to 2e relate to their counterpart, i.e., the service 201 for providing access to the asset. This service is provided by the method, apparatus/device, computer program and computer system discussed in connection with FIGS. 2a to 2e. The service 201 tightly interacts with the NFT smart contract and the token creation smart contract. Therefore, many aspects of the service 201 have been previously discussed in connection with FIGS. 1a to 1f.

Similar to the description of FIGS. 1a to 1f, the description of FIGS. 2a to 2e starts with initialization of the token creation smart contract (FIG. 2b), creation of the NFT smart contract (FIG. 2c) and ownership transfer of the NFT smart contract (FIG. 2d), albeit from the perspective of the service 201.

FIG. 2b shows an optional portion of the method that relates to an initialization of the token creation smart contract 102. Additional information on the initialization of the token creation smart contract 102 can be found in FIGS. 1b and 6, for example. For example, as shown in FIG. 2b, the method may comprise, as part of an initialization 210 of the token creation smart contract, obtaining 211, from the newly created token creation smart contract, an encryption key of the token creation smart contract. The method may further comprise, as part of the initialization 210 of the token creation smart contract, providing 212 a management encryption key being associated with the token creation smart contract to the token creation smart contract. For example, the method may comprise generating, in response to the encryption key of the token creation smart contract, the management encryption key associated with the token creation smart contract. For example, the management encryption key may be part of a key pair comprising the encryption key (e.g., the public key of the key pair) and a corresponding management decryption key (e.g., the private key of the key pair). Alternatively, the management encryption key may be a symmetric encryption key, i.e., a key to be used for encrypting and decrypting. For example, the management encryption key may be provided encrypted with the encryption key of the token creation smart contract.

The management encryption key may subsequently be used, by the token creation smart contract, to encrypt a creation package for initializing a new NFT smart contract, e.g., as part of an initialization 220 of a new NFT smart contract. FIG. 2c shows an optional portion of the method that relates to a creation of a new NFT smart contract 101. Additional information on the creation of the NFT smart contract can be found in FIGS. 1c and 7, for example. For example, the method may comprise, as part of the initialization 220 of the NFT smart contract, obtaining 221, from the token creation smart contract being executed in the trusted execution environment 14a, a creation package for creating the NFT smart contract. The creation package may include a capability specified by the token creation smart contract. As outlined above, the creation package may be encrypted using the management encryption key associated with the token creation smart contract, and may be decrypted, as part of the method, using the corresponding decryption key (if asymmetric cryptography is used) or the management encryption key itself (if symmetric cryptography is used). By decrypting the creation package, the creation package may be validated to have originated from the token creation smart contract. The method may comprise creating 222, as part of the initialization 220 of the NFT smart contract, an identity for the NFT smart contract (e.g., by generating a unique identifier) and a key pair (e.g., by generating the key pair) being associated with the identity of the NFT smart contract. The method may comprise providing 223 the identity and an encryption key of the key pair to the NFT smart contract. For example, the capability included in the creation package may be stored and used subsequently to validate requests provided/forwarded by the NFT smart contract.

In most cases, the initial owner of the NFT is the offering agent, which may be the creator of the asset or a third-party agent. To make the asset available to a user, ownership of the NFT smart contract may be transferred to the user. While the financial aspects of the transactions may be conducted on a separate (Layer 1) blockchain or using other means (e.g., without use of a blockchain), the ownership of the NFT smart contract is also handled as part of the TEE-anchored blockchain that includes the NFT smart contract. FIG. 2d shows an optional portion of the method that relates to ownership transfer 230 of the NFT smart contract 101. Additional information on the ownership transfer can be found in FIGS. 1d and 4 and 8, for example. For example, the method may comprise, as part of a transfer 230 in ownership of the NFT smart contract, obtaining 231 a transfer ownership package from the NFT smart contract. The method may comprise, as part of the transfer 230 in ownership of the NFT smart contract, regenerating 232, a key pair associated with an identity of the NFT smart contract. The method may comprise, as part of the transfer 230 in ownership of the NFT smart contract, providing 233 an encryption key of the key pair to the NFT smart contract in response to the transfer ownership package. This encryption key may subsequently used by the NFT smart contract to encrypt at least a portion of request packages.

Normal operation is described primarily in connection with FIGS. 2a (with respect to the service 201), 1a (with respect to the NFT smart contract), 4 and 9. From the perspective of the service 201, the method comprises obtaining 240 the (request package comprising) the request to perform the operation using the asset. As outlined in connection with FIGS. 1a to 1f, the request package is created by the NFT smart contract executed in the trusted execution environment 14a (of computer system 100). For example, at least a portion of the request package may be encrypted by the NFT smart contract. For example, the request package may correspond to a capability (message), comprising the unencrypted identity of the NFT smart contract, the session key encrypted with the encryption key, and the operation encrypted with the session key. Therefore, obtaining the request may comprise decrypting 245 at least a portion of the request package using a decryption key being associated with an identity of the NFT smart contract. For example, the request package may comprise a session key, which may be encrypted using the encryption key associated with the identity of the NFT smart contract, and which may be decrypted using the corresponding decryption key associated with the identity of the NFT smart contract. The session key, in turn, may be used to encrypt a portion of the request that relates to the operation to be performed. Using the decrypted session key, the portion of the request that relates to the operation to be performed may be decrypted.

As outlined above, in some examples, the creation package may comprise a capability specifying one or more operations that are permitted with respect to the request. This capability may now be used to validate the request, by checking whether the operation requested is permitted according to the capability. For example, the method may comprise validating 250 the request to perform the operation, e.g., by comparing the capability included in the creation package and the operation/capability included in the request package. If the NFT smart contract grants an owner of the NFT smart contract to perform the operation using the asset (according to the validation of the request), the method comprises performing 260 the operation included in the request. Both validating 250 the request and performing 260 the operation may be performed by a so-called capability engine of the service 201, as described further in connection with FIGS. 4 to 9. For example, the method may comprise, e.g., by the capability engine, translating the request into an instruction, and performing the instruction on the asset.

In the discussion so far, the asset has remained unspecified. For example, the asset may be any kind of digital asset on which an operation can be performed. For example, the asset may be a database, an API, a training dataset, or a computational resource etc. For example, if the asset is a database, the operation may relate to a query on the database. For example, if the asset comprises an API, the operation may relate to an operation being performed using the API. If the asset comprises a training dataset, the operation may relate to performing training of a machine-learning model. If the asset comprises a computational resource, the operation may relate to a computational task being performed using the computational resource. In some examples, the asset may comprise a machine-learning model. In this case, the operation may relate to performing inference on the machine-learning model.

Regardless of the type of operation, a result may be returned. Such a result may range from a status message (“success”, “error”), a query result (e.g., of the database query, of the inference) to a large package of data (e.g., a trained machine-learning model). The method comprises providing 270 the (result package with) the result of the operation for the NFT smart contract. This result package may be encrypted, e.g., using the session key. For example, providing the result package may comprise encrypting 275, using the session key included in the request package, the result package.

As discussed in connection with FIGS. 1a to 1f, there are two approaches for a communication between the NFT smart contract and the service 201. In a first approach, the NFT smart contract and the service do not communicate directly with each other, but via the current owner. Instead, the current owner interacts with the NFT smart contract, obtains the request package from the NFT smart contract, and provides the request package to the service 201. The current owner may then also obtain the result from the service and provide it to the NFT smart contract for decryption. In other words, the request package may be obtained from a current owner of the NFT smart contract, and the result package may be provided to the current owner of the NFT smart contract. In a second approach, the NFT smart contract and the service communicate directly. In this case, the request (package) may be obtained from the NFT smart contract, and the result (package) may be provided to the NFT smart contract.

In some examples, as shown in FIG. 2e, the service 201 may be at least partially provided in a TEE 24a, or a protected environment, where it preserves the integrity and confidentiality of the asset, or it may simply be authenticated. In other words, at least a portion of the method may be performed, by a processor 24 providing a trusted execution environment 24a, within the trusted execution environment. For example, operation related to encryption, decryption, generating and storing of encryption keys and/or performing the operation on the asset may be performed in the trusted execution environment.

The interface circuitry 22 or means for communicating 22 may correspond to one or more inputs and/or outputs for receiving and/or transmitting information, which may be in digital (bit) values according to a specified code, within a module, between modules or between modules of different entities. For example, the interface circuitry 22 or means for communicating 22 may comprise circuitry configured to receive and/or transmit information.

For example, the processor circuitry 24 or means for processing 24 may be implemented using one or more processing units, one or more processing devices, any means for processing, such as a processor, a computer or a programmable hardware component being operable with accordingly adapted software. In other words, the described function of the processor circuitry 24 or means for processing may as well be implemented in software, which is then executed on one or more programmable hardware components. Such hardware components may comprise a general-purpose processor, a Digital Signal Processor (DSP), a micro-controller, etc.

For example, the memory/storage circuitry 26 or memory/storage 26 may comprise at least one element of the group of a computer readable storage medium, such as a magnetic or optical storage medium, such as a random access memory, such as dynamic random-access memory (DRAM), a hard disk drive, a flash memory, Floppy-Disk, Random Access Memory (RAM), Programmable Read Only Memory (PROM), Erasable Programmable Read Only Memory (EPROM), an Electronically Erasable Programmable Read Only Memory (EEPROM), or a network storage.

More details and aspects of the method, computer program, apparatus 20, device 20 and computer system 200 are mentioned in connection with the proposed concept or one or more examples described above or below (e.g., FIG. 1a to 1f, 3 to 9). The method, computer program, apparatus 20, device 20 and computer system 200 may comprise one or more additional optional features corresponding to one or more aspects of the proposed concept, or one or more examples described above or below.

FIG. 3 shows a schematic diagram of an example of an NFT infrastructure, e.g., an NFT infrastructure in use today. This architecture may be considered insufficient to support NFTs for high-value confidential assets. The present disclosure provides enhancements and protocols to the above architecture to support NFTs for confidential assets.

FIG. 4 shows a schematic diagram of an example of an architecture to enable NFTs for high-value confidential assets. The architecture comprises an NFT marketplace 410 (with extension to support a Layer 2 blockchain). The Layer 1 blockchain 420 is used as a payment network (e.g., so Bob can pay Alice for performing operations on the asset). A L1/L2 bridge 430 is used to bridge between the Layer 1 blockchain 420 and a Layer 2 TEE-anchored Blockchain 440, which is used as token layer. The Layer 2 blockchain is implemented using the TEE and hosts the NFT token object smart contract 101 (i.e., the NFT smart contract 101 discussed in connection with FIGS. 1a to 2e). The NFT token object smart contract 101 defines two aspects—ownership, and access/use policy. The NFT token object smart contract can be used to perform an operation on the asset via a Guardian Service 201 (i.e., the service 201 discussed in connection with FIGS. 1a to 2e), which includes the asset and a capability engine, to perform the operation and/or to validate requests provided with help of the NFT token object smart contract. For example, a request package may be rejected if the capability cannot be validated; otherwise, it is accepted, thereby allowing the request to be served. In some examples, as shown in FIG. 4, the Guardian Service may be in a TEE 24a, or a protected environment, where it preserves the integrity and confidentiality of the asset, or it may simply be authenticated.

The NFT smart contract 101 is implemented in the TEE-anchored layer 2 blockchain 440. The layer 1 blockchain 420 acts as the payment layer. The NFT smart contract not only implements ownership, but also implements policies that determine usage of the asset. The proposed data exchange protocol ensures strong binding between the NFT smart contract and the asset-usage environment (via the Guardian Service 201).

In the following, two proposals are shown that enable NFTs to trade “policy-based usage-rights” for confidential assets. The first proposal is to use the system shown in FIG. 4 instead of the system in FIG. 3. Under this new system for NFTs, the NFT smart contract gets implemented it in a Trusted Execution Environment (TEE)-enabled Layer 2 blockchain 440. The NFT smart contract is used to not only implement ownership, but also implement/evaluate policy to be followed while using the confidential asset. The smart contract after policy evaluation generates asset-usage capabilities that get processed by capability execution engines implemented inside asset stores. For example, the NFT smart contract might share confidential information with the asset store only after verifying its trustworthiness (per policies implemented inside the smart contract). The payment layer may be implemented separately from the NFT token layer. The payment layer may be implemented either a Layer 1 blockchain (as shown in the picture) or via other methods such as PayPal accounts, etc. Receipt of payment from layer 1 may be used to initiate transfer of NFT ownership in layer 2. The NFT marketplace may be adapted so that it can facilitate transfer of NFTs defined in the TEE-anchored Layer 2 blockchain.

It is notated that the above system leverages some concepts from the system in FIG. 3, as well as the general notion of Layer 1/Layer 2 separation of blockchains, where a Layer 2 blockchain is used to provide functionality that cannot be directly provided by a Layer 1 blockchain. In the proposed concept, the Layer 2 implements NFT smart contracts protected by TEEs.

The second proposal is a set of secure data exchange protocols that may be followed by the Layer 2 blockchain in FIG. 2. This protocol (described below) does not make specific assumptions on Layer 1, the L1/L2 bridge and the marketplace. There are a few assumptions on the Guardian Service regarding use of cryptographic material that will be discussed as the part of the protocol. In addition, the protocol might not be restricted to a specific use-case, meaning the nature of the confidential asset, and the nature of the capability execution engine located within the Guardian Service are not specified herein. The proposed concept may be adapted to specific use-cases (such as NFTs for trading machine learning models) that contain additional aspects regarding the specification of the Guardian Service suitable for the specific use-case. In addition, the protocol might not capture novelties that may be required to adapt existing NFT marketplaces so that they can support NFTs (as described herein) supported via TEE-anchored Layer 2 blockchains. The protocol does not assume any specific choice of Layer 2 blockchain technology choice (with support for TEEs). For example, a Layer 2 blockchain such as Hyperledger Labs (a trademark of Hyperledger Foundation, hosted by The Linux Foundation) Private Data Objects (Hyperledger Private Data Objects, n.d.) or Fabric Private Chain-code (Fabric Private Chaincode, n.d.) or Oasis Network (Oasis Network, n.d.) may be used.

For describing the protocol, reference is made to a subsystem of FIG. 4, comprising (only) the Layer 2 and the Guardian Service.

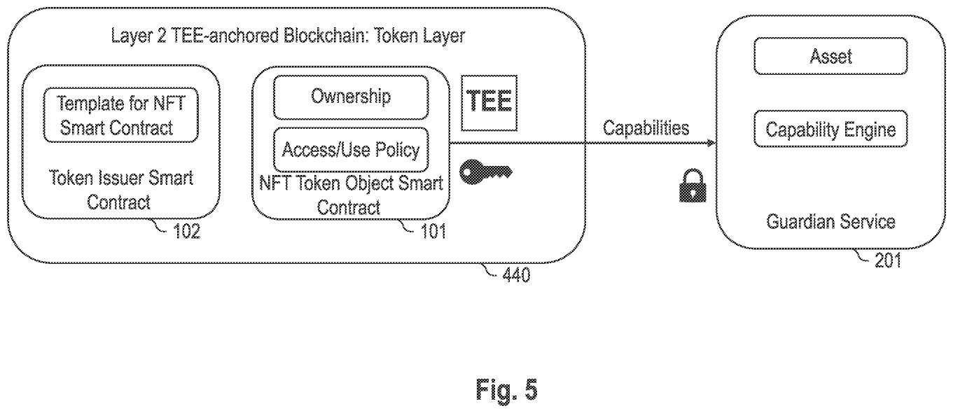

FIG. 5 shows a schematic diagram of an NFT sub-system showing components involved in the proposed secure data exchange protocol. With reference to FIG. 4, this includes the Layer 2 blockchain 440 and the Guardian Service 201 shown in FIG. 4. It is to be noted that the Layer 2 here, in addition to the NFT Smart Contract 101, additionally contains a Token Issuer Smart Contract 102 which acts as a point of entry for a prospective end-points (Alice in FIG. 4) that wants to deploy a NFT smart contract.

To describe the protocol, some additional terminology and acronyms are introduced in the following. An Offered/Digital Asset (DA), i.e., the asset discussed in connection with FIGS. 1a to 2e, is a digital asset that an OA (Offering Agent) wants to monetize. The Offering Agent (OA) is the agent initially offering DA. Generally, the OA runs the GS (Guardian Service), i.e., the service discussed in connection with FIGS. 1a to 2e. The CO is the Current Owner of the NFT smart contract, and the NO is the New Owner of the NFT smart contract. The Guardian Service (GS) is the service that manages access to the DA and verifies capabilities. The GS is (purely) operational, without applying policies. The GS maps capabilities to operations on the asset. A Token Issuer Object (TIO), i.e., the token creation smart contract discussed in connection with FIGS. 1a to 2e, is created by the OA and creates TOs (Token Objects, i.e., the NFT smart contract discussed in connection with FIGS. 1a to 2e) for the DA (issuer). The Token Object (TO), i.e., the NFT smart contract discussed in connection with FIGS. 1a to 2e, is created by a TIO, and generates capabilities that can be evaluated by the GS.

An example of a formal definition of a capability is provided in the following. Such a capability may be generated by the NFT smart contract after policy verification. Capabilities may be processed by the capability engine located within the Guardian Service. A capability may be defined as
CAP (EK, I, OP) [symbol] I, <encrypt(EK, SK), IV, encrypt(SK, OP)>>
   where I is the minted identity, EK is the GS's public (RSA) encryption key associated with identity I, IV is the AES initialization vector, OP is the operation to be performed (e.g., in JSON format), SK is the (AES) session key. The JSON encoded (capability) message may include the unencrypted token identity, the session key encrypted with the public asymmetric key, and the operation encrypted with the session key.

The protocol is divided into four phases, Initialization Phase, Creating an NFT, Transferring an NFT and Invoking an operation. The Initialization phase is shown primarily in FIG. 6 and FIGS. 1b and 2b. The NFT creation phase is shown primarily in FIG. 7 and FIGS. 1c and 2c. The Transferring an NFT phase is shown primarily in FIG. 8 and FIGS. 1d and 2d. The Invoking an operation phase is shown primarily in FIG. 9 and FIGS. 1a and 2a. An example protocol for each of these phases are shown below using the terminology described above.

FIG. 6 illustrates operations performed during initialization (Initialization Phase) of a token issuer smart contract according to an example. FIG. 6 shows the Token Issuer Smart Contract (TIO) 102, including a template for a NFT Smart Contract, and the Guardian Service 201, which includes the asset and the capability engine. At (1), the GS creates a management encryption key pair (RSA). At (2), the OA creates the TIO and retrieves the TIO's RSA encryption key. At (3), the OA submits the TIO encryption key for initial provisioning. The guardian responds with the TIO initialization package which includes the management encryption key. This package is encrypted with the TIO's encryption key. At (4), the OA provisions the TIO with the initialization package from the GS.

FIG. 7 illustrates operations performed during creation of a NFT smart contract (NFT Token Object Smart Contract) 101 according to an example. FIG. 7 shows the NFT Token Object Smart Contract 101, the Token Issuer Smart Contract 102, and the Guardian Service 201 (including asset and capability engine). At (1), the OA creates a TO and generates an attestation package; the attestation package is submitted to the TIO. The OA is assigned as the current owner of the TO. At (2), the TIO verifies the TO attestation package and generates a TO creation package that includes a capability (encrypted with the GS's management encryption key). At (3), the OA submits the TO creation package to the GS. The GS creates a new identity with corresponding encryption key and returns a TO initialization package. At (4), the OA submits the initialization package to the token object provisioning it with an identity and capability key.

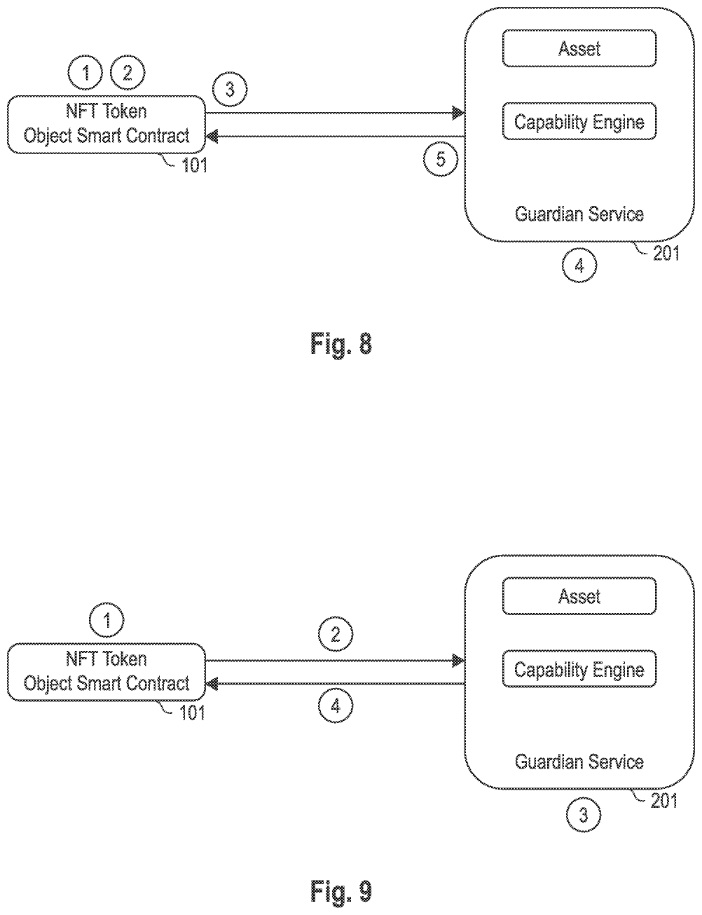

FIG. 8 illustrates operations performed during transfer of ownership of a NFT smart contract (NFT Token Object Smart Contract) 101 according to an example. FIG. 8 shows the NFT Token Object Smart Contract 101 and the Guardian Service 201 (including asset and capability engine).At (1), the CO invokes the transfer method on the token object with the NO's identity. At (2), the NO invokes the reset keys method and receives a transfer ownership package. At (3), the NO submits the transfer ownership package to the guardian service. At (4), the GS creates a new key pair and returns a transfer package that includes the encryption key. At (5), the NO invokes the complete transfer method with the transfer package.

FIG. 9 illustrates operations performed when invoking an operation according to an example. FIG. 9 shows the NFT Token Object Smart Contract 101 and the Guardian Service 201 (including asset and capability engine). At (1), the CO invokes the invoke method on the TO with an image to be classified (as an example of an operation to be performed). The TO returns an invocation package that includes the invocation request encrypted with the capability encryption key and session encryption key. At (2), the CO submits the invocation package to the GS. At (3), the GS invokes the operation and returns the results encrypted with the session key. At (4), the CO submits the response package to the TO, which decrypts it and returns the results.

More details and aspects of the concept for policy-based usage-rights for confidential assets are mentioned in connection with the proposed concept or one or more examples described above or below (e.g., FIG. 1a to 2e). The concept for policy-based usage-rights for confidential assets may comprise one or more additional optional features corresponding to one or more aspects of the proposed concept, or one or more examples described above or below.

In the following, some examples of the proposed concept are presented:

An example (e.g., example 1) relates to a method comprising obtaining (140), by a non-fungible token (NFT) smart contract (101) being executed in a trusted execution environment (14a), a request to perform an operation using the asset. The method comprises providing (160), by the NFT smart contract, the request for a service for providing access to the as set if the request is obtained from a current owner of the NFT smart contract. The method comprises obtaining (170), by the NFT smart contract, a result provided by the service for providing access to the asset, the result being based on the request. The method comprises providing (180), by the NFT smart contract, the result for the current owner of the NFT smart contract.

Another example (e.g., example 2) relates to a previously described example (e.g., example 1) or to any of the examples described herein, further comprising that the NFT smart contract grants the current owner of the NFT smart contract the right to perform one or more operations on the asset.

Another example (e.g., example 3) relates to a previously described example (e.g., one of the examples 1 to 2) or to any of the examples described herein, further comprising that the method comprises checking (150), by the NFT smart contract, whether the request is permissible according to at least one pre-defined policy, wherein the request is provided if the request is obtained from the current owner of the NFT smart contract and the request is permissible.

Another example (e.g., example 4) relates to a previously described example (e.g., one of the examples 1 to 3) or to any of the examples described herein, further comprising that the NFT smart contract provides the request as part of a request package to the current owner of the NFT smart contract and obtains the result as part of a result package from the current owner of the NFT smart contract.

Another example (e.g., example 5) relates to a previously described example (e.g., one of the examples 1 to 3) or to any of the examples described herein, further comprising that the NFT smart contract provides the request to the service for providing access to the asset and obtains the result from the service for providing access to the asset.

Another example (e.g., example 6) relates to a previously described example (e.g., one of the examples 1 to 5) or to any of the examples described herein, further comprising that providing (160) the request comprises encrypting (165), by the NFT smart contract, at least a portion of a request package comprising the request using an encryption key provided by the service for providing access to the asset, the encryption key being associated with an identity of the NFT smart contract.

Another example (e.g., example 7) relates to a previously described example (e.g., example 6) or to any of the examples described herein, further comprising that the method comprises, during an initialization (120) of the NFT smart contract, obtaining (124) the encryption key being associated with the identity of the NFT smart contract from the service for providing access to the asset.

Another example (e.g., example 8) relates to a previously described example (e.g., one of the examples 1 to 7) or to any of the examples described herein, further comprising that obtaining the result comprises decrypting (175), using a session key included in a request package being provided for the service, a result package.

Another example (e.g., example 9) relates to a previously described example (e.g., one of the examples 1 to 8) or to any of the examples described herein, further comprising that the method comprises, to transfer (130) the NFT smart contract to a new owner, by the NFT smart contract, obtaining (131) a transfer request to transfer ownership of the NFT smart contract, checking (132), whether the transfer request is obtained from the current owner of the NFT smart contract, resetting (133) one or more encryption keys contained in the NFT smart contract, providing (134) a transfer ownership package for the service for providing access to the asset, and obtaining (135) an encryption key being associated with an identity of the NFT smart contract from the service for providing access to the asset, the encryption key being provided in response to the transfer ownership package.

Another example (e.g., example 10) relates to a previously described example (e.g., one of the examples 1 to 9) or to any of the examples described herein, further comprising that the method comprises, to initialize (120) the NFT smart contract, verifying (122), by a token creation smart contract being executed in the trusted execution environment, an attestation package provided (121) by the newly created NFT smart contract, providing (123), by the token creation smart contract, a creation package to the service for providing access to the asset, and obtaining (124), by the NFT smart contract, an identity and an encryption key being associated with an identity of the NFT smart contract from the service for providing access to the asset, the encryption key being provided in response to the creation package.

Another example (e.g., example 11) relates to a previously described example (e.g., example 10) or to any of the examples described herein, further comprising that the method comprises, to initialize (110) the token creation smart contract, providing (111), by the newly created token creation smart contract, an encryption key of the token creation smart contract to the service for providing access to the asset, and obtaining (112), by the token creation smart contract, a management encryption key from the service for providing access to the asset, wherein the creation package for initializing a new NFT smart contract is encrypted using the management encryption key.

An example (e.g., example 12) relates to an apparatus (10) comprising an interface (12) for communicating with a service for providing access to an asset. The apparatus (10) comprises machine-readable instructions (16a). The apparatus (10) comprises processor circuitry (14) with a trusted execution environment (14a) to execute the machine-readable instructions inside the trusted execution environment to perform the method according to one of the examples 1 to 11.

An example (e.g., example 13) relates to a method for a service for providing access to an asset, the method comprising obtaining (240) a request to perform an operation using the asset, the request being provided by a non-fungible token (NFT) smart contract executed in a trusted execution environment. The method comprises performing (260), if the NFT smart contract grants an owner of the NFT smart contract to perform the operation using the asset, the operation included in the request. The method comprises providing (270) a result of the operation for the NFT smart contract.

Another example (e.g., example 14) relates to a previously described example (e.g., example 13) or to any of the examples described herein, further comprising that the request is obtained as part of a request package from a current owner of the NFT smart contract, and the result is provided as part of a result package to the current owner of the NFT smart contract.

Another example (e.g., example 15) relates to a previously described example (e.g., example 13) or to any of the examples described herein, further comprising that the request is obtained from the NFT smart contract, and the result is provided to the NFT smart contract.

Another example (e.g., example 16) relates to a previously described example (e.g., one of the examples 13 to 15) or to any of the examples described herein, further comprising that obtaining the request comprises decrypting (245) at least a portion of a request package comprising the request using a decryption key being associated with an identity of the NFT smart contract.

Another example (e.g., example 17) relates to a previously described example (e.g., example 16) or to any of the examples described herein, further comprising that the decryption key being associated with the identity of the NFT smart contract is part of a key pair associated with the identity of the NFT smart contract, the method comprising, during an initialization (220) of the NFT smart contract, providing (223) an encryption key of the key pair associated with the identity of the NFT smart contract to the NFT smart contract.

Another example (e.g., example 18) relates to a previously described example (e.g., one of the examples 13 to 17) or to any of the examples described herein, further comprising that providing the result comprises encrypting (275), using a session key included in a request package comprising the request, a result package comprising the result.

Another example (e.g., example 19) relates to a previously described example (e.g., one of the examples 13 to 18) or to any of the examples described herein, further comprising that the method comprises, as part of a transfer (230) in ownership of the NFT smart contract, obtaining (231) a transfer ownership package from the NFT smart contract, regenerating (232) a key pair associated with an identity of the NFT smart contract, and providing (233) an encryption key of the key pair to the NFT smart contract in response to the transfer ownership package.

Another example (e.g., example 20) relates to a previously described example (e.g., one of the examples 13 to 19) or to any of the examples described herein, further comprising that the method comprises, as part of an initialization (220) of the NFT smart contract, obtaining (221), from a token creation smart contract being executed in the trusted execution environment (14a), a creation package for creating the NFT smart contract, creating (222) an identity for the NFT smart contract and a key pair being associated with the identity of the NFT smart contract, and providing (223) the identity and an encryption key of the key pair to the NFT smart contract.

Another example (e.g., example 21) relates to a previously described example (e.g., example 20) or to any of the examples described herein, further comprising that the method comprises, as part of an initialization (210) of the token creation smart contract, obtaining (211), from the newly created token creation smart contract, an encryption key of the token creation smart contract, and providing (212) a management encryption key being associated with the token creation smart contract to the token creation smart contract, wherein the creation package for initializing a new NFT smart contract is encrypted using the management encryption key.

Another example (e.g., example 22) relates to a previously described example (e.g., one of the examples 13 to 21) or to any of the examples described herein, further comprising that the asset comprises a machine-learning model, wherein the operation relates to performing inference on the machine-learning model.

Another example (e.g., example 23) relates to a previously described example (e.g., one of the examples 13 to 22) or to any of the examples described herein, further comprising that the method comprises validating (250) the request to perform the operation.

Another example (e.g., example 24) relates to a previously described example (e.g., one of the examples 13 to 23) or to any of the examples described herein, further comprising that the method is performed, by a processor (24) providing a trusted execution environment (24a), within the trusted execution environment.

An example (e.g., example 25) relates to an apparatus (20) for a service for providing access to an asset, the apparatus comprising an interface (22) for communicating with at least one smart contract being executed within a trusted execution environment. The apparatus (20) comprises machine-readable instructions (26a). The apparatus (20) comprises processor circuitry (24) to execute the machine-readable instructions to perform the method according to one of the examples 13 to 24.

An example (e.g., example 26) relates to a system comprising the apparatus (10) according to example 11 and the apparatus (20) according to example 25.

An example (e.g., example 27) relates to an apparatus (10) comprising an interface (12) for communicating with a service for providing access to an asset. The apparatus (10) comprises machine-readable instructions (16a). The apparatus (10) comprises processor circuitry (14) with a trusted execution environment to (14a) execute the machine-readable instructions inside the trusted execution environment to obtain, by a non-fungible token (NFT) smart contract being executed in a trusted execution environment, a request to perform an operation using the asset, provide, by the NFT smart contract, the request for a service for providing access to the asset if the request is obtained from a current owner of the NFT smart contract, obtain, by the NFT smart contract, a result provided by the service for providing access to the asset, the result being based on the request, and provide, by the NFT smart contract, the result for the current owner of the NFT smart contract.

An example (e.g., example 28) relates to an apparatus (20) for a service for providing access to an asset, the apparatus comprising an interface (22) for communicating with at least one smart contract being executed within a trusted execution environment. The apparatus (20) comprises machine-readable instructions (26a). The apparatus (20) comprises processor circuitry (24) to execute the machine-readable instructions to obtain a request to perform an operation using the asset, the request being provided by a non-fungible token (NFT) smart contract executed in a trusted execution environment, perform, if the NFT smart contract grants an owner of the NFT smart contract to perform the operation using the asset, the operation included in the request, and provide a result of the operation for the NFT smart contract.

An example (e.g., example 29) relates to a system comprising the apparatus (10) according to example 27 and the apparatus (20) according to example 28.

An example (e.g., example 30) relates to a device (10) comprising means for communicating (12) with a service for providing access to an asset. The device (10) comprises means for processing (14) for providing a trusted execution environment (14a), and for performing, within the trusted execution environment obtaining, by a non-fungible token (NFT) smart contract being executed in the trusted execution environment, a request to perform an operation using the asset, providing, by the NFT smart contract, the request for a service for providing access to the asset if the request is obtained from a current owner of the NFT smart contract, obtaining, by the NFT smart contract, a result provided by the service for providing access to the asset, the result being based on the request, and providing, by the NFT smart contract, the result for the current owner of the NFT smart contract.

An example (e.g., example 31) relates to a device (20) for a service for providing access to an asset, the apparatus comprising means for communicating (22) with at least one smart contract being executed within a trusted execution environment. The device (20) comprises means for processing (24) for obtaining a request to perform an operation using the asset, the request being provided by a non-fungible token (NFT) smart contract executed in a trusted execution environment, performing, if the NFT smart contract grants an owner of the NFT smart contract to perform the operation using the asset, the operation included in the request, and providing a result of the operation for the NFT smart contract.

An example (e.g., example 32) relates to a system comprising the device (10) according to example 30 (or according to any other example) and the device (20) according to example 31 (or according to any other example).

An example (e.g., example 33) relates to a computer system (100) comprising one of the apparatus (10) of example 12 (or according to any other example), the apparatus (10) of example 27 (or according to any other example), or the device (10) of example 30 (or according to any other example).

An example (e.g., example 34) relates to a computer system (100) being configured to perform the method of one of the examples 1 to 11 (or according to any other example).

An example (e.g., example 35) relates to a computer system (200) comprising one of the apparatus (20) of example 25 (or according to any other example), the apparatus (20) of example 28 (or according to any other example), or the device (20) of example 31 (or according to any other example).

An example (e.g., example 36) relates to a computer system (200) being configured to perform the method of one of the examples 13 to 24 (or according to any other example).

An example (e.g., example 37) relates to a non-transitory machine-readable storage medium including program code, when executed, to cause a machine to perform the method of one of the examples 1 to 11 (or according to any other example), or the method of one of the examples 13 to 24 (or according to any other example).

An example (e.g., example 38) relates to a computer program having a program code for performing the method of one of the examples 1 to 11 (or according to any other example), or the method of one of the examples 13 to 24 (or according to any other example) when the computer program is executed on a computer, a processor, or a programmable hardware component.

An example (e.g., example 39) relates to a machine-readable storage including machine readable instructions, when executed, to implement a method or realize an apparatus as claimed in any pending claim or shown in any example.

The aspects and features described in relation to a particular one of the previous examples may also be combined with one or more of the further examples to replace an identical or similar feature of that further example or to additionally introduce the features into the further example.

Examples may further be or relate to a (computer) program including a program code to execute one or more of the above methods when the program is executed on a computer, processor, or other programmable hardware component. Thus, steps, operations, or processes of different ones of the methods described above may also be executed by programmed computers, processors, or other programmable hardware components. Examples may also cover program storage devices, such as digital data storage media, which are machine-, processor- or computer-readable and encode and/or contain machine-executable, processor-executable or computer-executable programs and instructions. Program storage devices may include or be digital storage devices, magnetic storage media such as magnetic disks and magnetic tapes, hard disk drives, or optically readable digital data storage media, for example. Other examples may also include computers, processors, control units, (field) programmable logic arrays ((F)PLAs), (field) programmable gate arrays ((F)PGAs), graphics processor units (GPU), application-specific integrated circuits (ASICs), integrated circuits (ICs) or system-on-a-chip (SoCs) systems programmed to execute the steps of the methods described above.

It is further understood that the disclosure of several steps, processes, operations, or functions disclosed in the description or claims shall not be construed to imply that these operations are necessarily dependent on the order described, unless explicitly stated in the individual case or necessary for technical reasons. Therefore, the previous description does not limit the execution of several steps or functions to a certain order. Furthermore, in further examples, a single step, function, process, or operation may include and/or be broken up into several sub-steps, -functions, -processes or -operations.

If some aspects have been described in relation to a device or system, these aspects should also be understood as a description of the corresponding method. For example, a block, device or functional aspect of the device or system may correspond to a feature, such as a method step, of the corresponding method. Accordingly, aspects described in relation to a method shall also be understood as a description of a corresponding block, a corresponding element, a property or a functional feature of a corresponding device or a corresponding system.

As used herein, the term “module” refers to logic that may be implemented in a hardware component or device, software or firmware running on a processing unit, or a combination thereof, to perform one or more operations consistent with the present disclosure. Software and firmware may be embodied as instructions and/or data stored on non-transitory computer-readable storage media. As used herein, the term “circuitry” can comprise, singly or in any combination, non-programmable (hardwired) circuitry, programmable circuitry such as processing units, state machine circuitry, and/or firmware that stores instructions executable by programmable circuitry. Modules described herein may, collectively or individually, be embodied as circuitry that forms a part of a computing system. Thus, any of the modules can be implemented as circuitry. A computing system referred to as being programmed to perform a method can be programmed to perform the method via software, hardware, firmware, or combinations thereof.

Any of the disclosed methods (or a portion thereof) can be implemented as computer-executable instructions or a computer program product. Such instructions can cause a computing system or one or more processing units capable of executing computer-executable instructions to perform any of the disclosed methods. As used herein, the term “computer” refers to any computing system or device described or mentioned herein. Thus, the term “computer-executable instruction” refers to instructions that can be executed by any computing system or device described or mentioned herein.

The computer-executable instructions can be part of, for example, an operating system of the computing system, an application stored locally to the computing system, or a remote application accessible to the computing system (e.g., via a web browser). Any of the methods described herein can be performed by computer-executable instructions performed by a single computing system or by one or more networked computing systems operating in a network environment. Computer-executable instructions and updates to the computer-executable instructions can be downloaded to a computing system from a remote server.

Further, it is to be understood that implementation of the disclosed technologies is not limited to any specific computer language or program. For instance, the disclosed technologies can be implemented by software written in C++, C #, Java, Perl, Python, JavaScript, Adobe Flash, C #, assembly language, or any other programming language. Likewise, the disclosed technologies are not limited to any particular computer system or type of hardware.

Furthermore, any of the software-based examples (comprising, for example, computer-executable instructions for causing a computer to perform any of the disclosed methods) can be uploaded, downloaded, or remotely accessed through a suitable communication means. Such suitable communication means include, for example, the Internet, the World Wide Web, an intranet, cable (including fiber optic cable), magnetic communications, electromagnetic communications (including RF, microwave, ultrasonic, and infrared communications), electronic communications, or other such communication means.

The disclosed methods, apparatuses, and systems are not to be construed as limiting in any way. Instead, the present disclosure is directed toward all novel and nonobvious features and aspects of the various disclosed examples, alone and in various combinations and subcombinations with one another. The disclosed methods, apparatuses, and systems are not limited to any specific aspect or feature or combination thereof, nor do the disclosed examples require that any one or more specific advantages be present, or problems be solved.

Theories of operation, scientific principles, or other theoretical descriptions presented herein in reference to the apparatuses or methods of this disclosure have been provided for the purposes of better understanding and are not intended to be limiting in scope. The apparatuses and methods in the appended claims are not limited to those apparatuses and methods that function in the manner described by such theories of operation.

The following claims are hereby incorporated in the detailed description, wherein each claim may stand on its own as a separate example. It should also be noted that although in the claims a dependent claim refers to a particular combination with one or more other claims, other examples may also include a combination of the dependent claim with the subject matter of any other dependent or independent claim. Such combinations are hereby explicitly proposed, unless it is stated in the individual case that a particular combination is not intended. Furthermore, features of a claim should also be included for any other independent claim, even if that claim is not directly defined as dependent on that other independent claim.

What is claimed is:

1. A method comprising:
obtaining, by a non-fungible token (NFT) smart contract being executed in a trusted execution environment, a request to perform an operation using the asset;
providing, by the NFT smart contract, the request for a service for providing access to the asset if the request is obtained from a current owner of the NFT smart contract;
obtaining, by the NFT smart contract, a result provided by the service for providing access to the asset, the result being based on the request; and
providing, by the NFT smart contract, the result for the current owner of the NFT smart contract.

2. The method according to claim 1, wherein the NFT smart contract grants the current owner of the NFT smart contract the right to perform one or more operations on the asset.

3. The method according to claim 1, wherein the method comprises checking, by the NFT smart contract, whether the request is permissible according to at least one pre-defined policy, wherein the request is provided if the request is obtained from the current owner of the NFT smart contract and the request is permissible.

4. The method according to claim 1, wherein the NFT smart contract provides the request as part of a request package to the current owner of the NFT smart contract and obtains the result as part of a result package from the current owner of the NFT smart contract.

5. The method according to claim 1, wherein the NFT smart contract provides the request to the service for providing access to the asset and obtains the result from the service for providing access to the asset.

6. The method according to claim 1, wherein providing the request comprises encrypting, by the NFT smart contract, at least a portion of a request package comprising the request using an encryption key provided by the service for providing access to the asset, the encryption key being associated with an identity of the NFT smart contract.

7. The method according to claim 1, wherein obtaining the result comprises decrypting, using a session key included in a request package being provided for the service, a result package.

8. The method according to claim 1, wherein the method comprises, to transfer the NFT smart contract to a new owner, by the NFT smart contract, obtaining a transfer request to transfer ownership of the NFT smart contract, checking, whether the transfer request is obtained from the current owner of the NFT smart contract, resetting one or more encryption keys contained in the NFT smart contract, providing a transfer ownership package for the service for providing access to the asset, and obtaining an encryption key being associated with an identity of the NFT smart contract from the service for providing access to the asset, the encryption key being provided in response to the transfer ownership package.

9. An apparatus comprising:
an interface for communicating with a service for providing access to an asset;
machine-readable instructions; and
processor circuitry with a trusted execution environment to execute the machine-readable instructions inside the trusted execution environment to perform the method according to claim 1.

10. A method for a service for providing access to an asset, the method comprising:
obtaining a request to perform an operation using the asset, the request being provided by a non-fungible token (NFT) smart contract executed in a trusted execution environment;
performing, if the NFT smart contract grants an owner of the NFT smart contract to perform the operation using the asset, the operation included in the request;
providing a result of the operation for the NFT smart contract.

11. The method according to claim 10, wherein the request is obtained as part of a request package from a current owner of the NFT smart contract, and the result is provided as part of a result package to the current owner of the NFT smart contract.

12. The method according to claim 10, wherein the request is obtained from the NFT smart contract, and the result is provided to the NFT smart contract.

13. The method according to claim 10, wherein obtaining the request comprises decrypting at least a portion of a request package comprising the request using a decryption key being associated with an identity of the NFT smart contract.

14. The method according to claim 13, wherein the decryption key being associated with the identity of the NFT smart contract is part of a key pair associated with the identity of the NFT smart contract, the method comprising, during an initialization of the NFT smart contract, providing an encryption key of the key pair associated with the identity of the NFT smart contract to the NFT smart contract.

15. The method according to claim 10, wherein providing the result comprises encrypting, using a session key included in a request package comprising the request, a result package comprising the result.

16. The method according to claim 10, wherein the method comprises, as part of a transfer in ownership of the NFT smart contract, obtaining a transfer ownership package from the NFT smart contract, regenerating a key pair associated with an identity of the NFT smart contract, and providing an encryption key of the key pair to the NFT smart contract in response to the transfer ownership package.

17. The method according to claim 10, wherein the asset comprises a machine-learning model, wherein the operation relates to performing inference on the machine-learning model.

18. An apparatus for a service for providing access to an asset, the apparatus comprising:
an interface for communicating with at least one smart contract being executed within a trusted execution environment;
machine-readable instructions; and
processor circuitry to execute the machine-readable instructions to perform the method according to claim 10.

19. A non-transitory machine-readable storage medium including program code, when executed, to cause a machine to perform the method of claim 1.

20. A non-transitory machine-readable storage medium including program code, when executed, to cause a machine to perform the method of claim 10.
